(19) United States
(12) Patent Application Publication
(10) Pub. No.: US 2026/0145565 A1
(43) Pub. Date: May 28, 2026

(54) SELF-PROPELLED CHARGING DEVICE

(71) Applicant: TOYOTA JIDOSHA KABUSHIKI KAISHA, Toyota-shi (JP)

(72) Inventor: Naoki MARUKAWA, Sunto-gun (JP)

(73) Assignee: TOYOTA JIDOSHA KABUSHIKI KAISHA, Toyota-shi (JP)

(21) Appl. No.: 19/177,977

(22) Filed: Apr. 14, 2025

(30) Foreign Application Priority Data
Sep. 12, 2024 (JP) 2024-158039

(51) Int. Cl. B60L 53/35

(52) U.S. Cl. CPC B60L 53/35

(57) ABSTRACT

The self-propelled charging device includes a device-side connector that is connected to a vehicle-side connector to charge a battery of the vehicle, an elevating mechanism that raises and lowers the device-side connector, and a plurality of joints provided on a base of the device-side connector and having two or more degrees of freedom.

### CROSS-REFERENCE TO RELATED APPLICATION

This application claims priority to Japanese Patent Application No. 2024-158039 filed on Sep. 12, 2024. The disclosure of the above-identified application, including the specification, drawings, and claims, is incorporated by reference herein in its entirety.

### BACKGROUND

### 1. Technical Field

The present disclosure relates to a self-propelled charging device.

### 2. Description of Related Art

Japanese Unexamined Patent Application Publication No. 2012-016084 (JP 2012-016084 A) discloses a self-propelled charging device that aligns a connector using a plurality of sensors.

### SUMMARY

In the technique disclosed in JP 2012-016084 A, a plurality of sensors for detecting the position of a vehicle-side connector is used, and therefore there is room for improvement in terms of cost.

The present disclosure can provide a self-propelled charging device capable of reducing a cost by reducing sensors for detecting the position of a vehicle-side connector.

An aspect of the present disclosure provides a self-propelled charging device including:
a device-side connector that charges a battery of a vehicle by being connected to a vehicle-side connector;
an elevating mechanism that elevates and lowers the device-side connector; and
a plurality of joints having two or more degrees of freedom and provided on a base of the device-side connector.

According to the present disclosure, the vehicle-side connector can be aligned easily by providing the base of the device-side connector with joints, and therefore it is possible to reduce the cost by reducing sensors for detecting the position of the vehicle-side connector.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side view illustrating a schematic configuration of a self-propelled charging device according to a first embodiment;

FIG. 2 is a plan view illustrating a schematic configuration of a self-propelled charging device according to Embodiment 1;

FIG. 3A is a side view of a part of an operation flow of the self-propelled charging device according to the first embodiment;

FIG. 3B is a side view of a part of the operation flow of the self-propelled charging device according to the first embodiment;

FIG. 3C is a side view of a part of the operation flow of the self-propelled charging device according to the first embodiment;

FIG. 3D is a side view of a part of the operation flow of the self-propelled charging device according to the first embodiment;

FIG. 3E is a side view of a part of the operation flow of the self-propelled charging device according to the first embodiment;

FIG. 3F is a side view of a part of the operation flow of the self-propelled charging device according to the first embodiment;

FIG. 4 is a side view illustrating a schematic configuration of a self-propelled charging device according to a second embodiment;

FIG. 5 is a plan view illustrating a schematic configuration of a self-propelled charging device according to a second embodiment;

FIG. 6 is a side view illustrating a schematic configuration of a self-propelled charging device according to a third embodiment;

FIG. 7 is a plan view illustrating a schematic configuration of a self-propelled charging device according to a third embodiment;

FIG. 8 is a side view illustrating a schematic configuration of a self-propelled charging device according to Embodiment 4; and

FIG. 9 is a plan view illustrating a schematic configuration of a self-propelled charging device according to a fourth embodiment.

### DETAILED DESCRIPTION OF EMBODIMENTS

A self-propelled charging device according to an embodiment of the present disclosure will be described with reference to the drawings. Incidentally, the constituent elements in the following embodiments include those that can be easily replaced by a person skilled in the art or those that are substantially the same.

### Embodiment 1

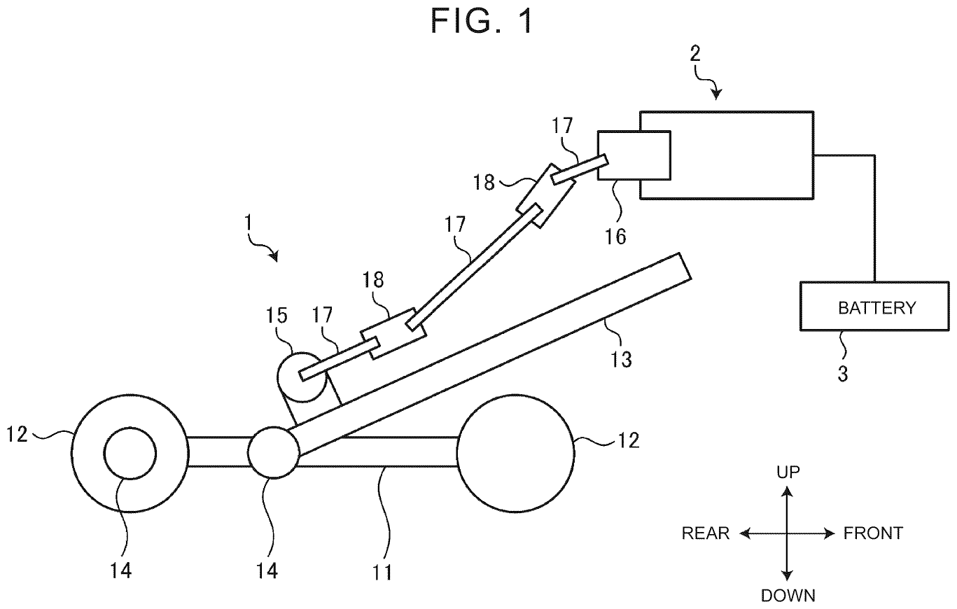

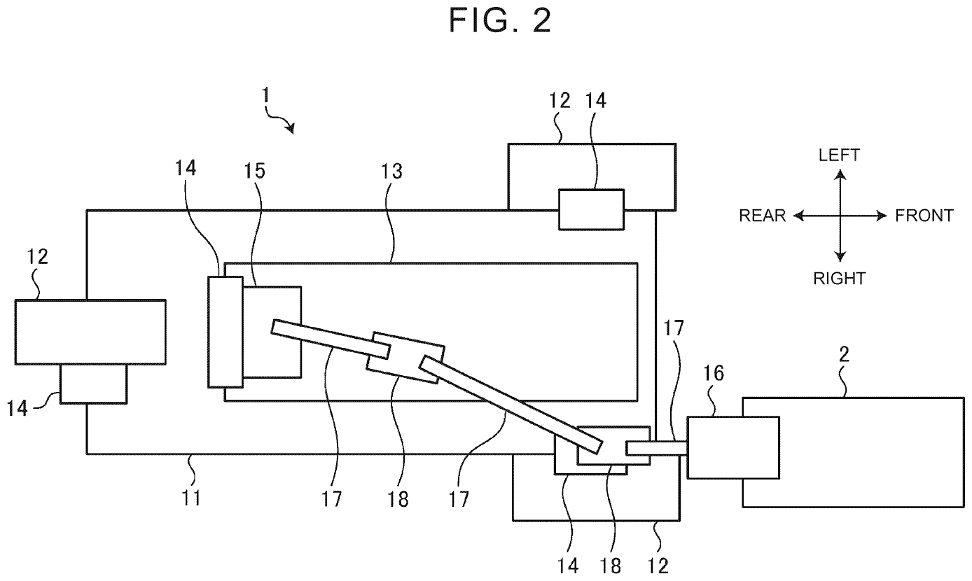

A configuration of the self-propelled charging device according to the first embodiment will be described with reference to FIGS. 1 and 2. The self-propelled charging device according to the embodiment is for self-propelled approaching a vehicle including a battery and automatically performing charging. The self-propelled charging device may autonomously travel using a sensing technique such as various sensors, or may travel by remote control by an operator or the like. Examples of vehicles to be charged by the self-propelled charging device include plug-in hybrid electric vehicle (PHEV), battery electric vehicle (BEV), and the like.

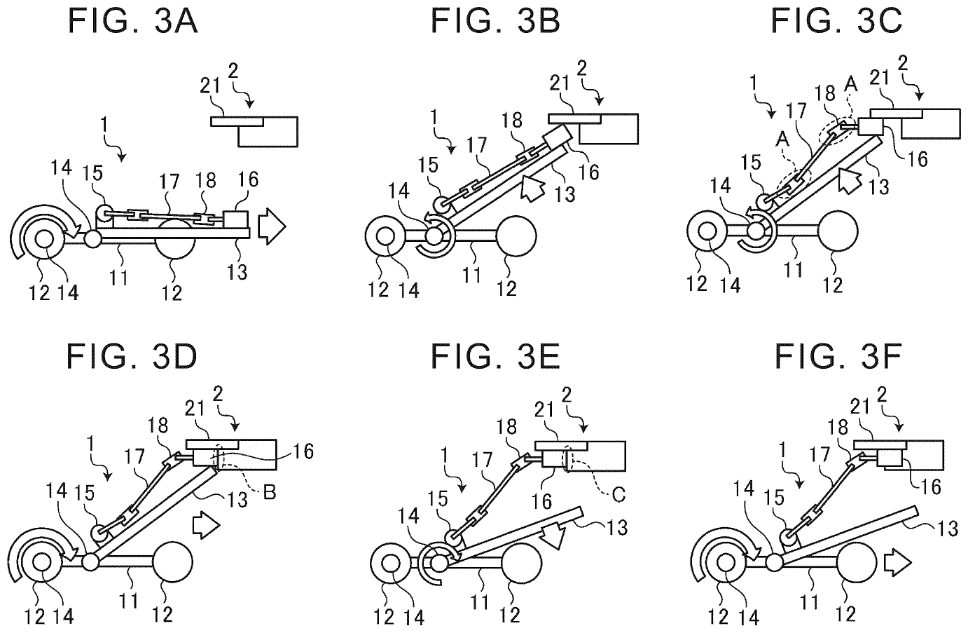

The self-propelled charging device 1 according to the first embodiment includes a main body portion 11, a plurality of wheels 12, a lower plate 13, a plurality of motors 14, a rotation mechanism 15, a device-side connector 16, a plurality of bases 17, and a plurality of joints 18 having two degrees of freedom or more. The vehicle to be charged includes a vehicle-side connector 2 and a battery 3. Although not illustrated in FIGS. 1 and 2, the vehicle-side connector 2 is provided with a guiding portion (upper cover) 21 for guiding the device-side connector 16 (see FIGS. 3A to 3F). In FIG. 1 and FIG. 2, only a part of the actual configuration of the vehicle is shown as an excerpt.

Further, the self-propelled charging device 1 is for performing charging via a vehicle-side connector 2 provided at a lower portion of the vehicle. As shown in FIG. 2, the lower plate 13, the device-side connector 16, the base 17, and the joint 18 are arranged along the front-rear direction of the self-propelled charging device 1.

A plurality of (three in this case) wheels 12 are attached to the main body 11. A driving motor 14 is provided inside each of the wheels 12. The motor 14 provided on the wheel 12 is used to move the self-propelled charging device 1 itself.

The lower plate 13 is a plate-shaped member and functions as an elevating mechanism for raising and lowering the device-side connector 16. The lower plate 13 has, for example, a rectangular shape in plan view as shown in FIG. 2, and long sides are arranged in the front-rear direction of the self-propelled charging device 1. One end of the lower plate 13 is supported by the main body 11. Further, a motor 14 for moving the lower plate 13 up and down with one end of the lower plate 13 as a base point is provided at one end of the lower plate 13. The motor 14 provided on the lower plate 13 is for moving the device-side connector 16.

The rotation mechanism 15 is for rotatably supporting the base 17 and the joint 18 connected to the base 17. A bearing or the like is provided inside the rotation mechanism 15. The device-side connector 16 is connected to the vehicle-side connector 2 and is used to charge the battery 3 of the vehicle. A charging station (not shown) is connected to the device-side connector 16.

The base 17 is provided between the rotation mechanism 15 and the joint 18, between the two joints 18, and between the joint 18 and the device-side connector 16. The joint 18 is provided on the base 17 of the device-side connector 16. That is, the joint 18 is provided between the two bases 17. Further, the joint 18 is constituted by a joint component having two degrees of freedom or more, such as a universal joint or a ball joint.

An exemplary operation of the self-propelled charging device 1 when recharging vehicles will be described referring to 3F from 3A of the drawings. First, the self-propelled charging device 1 moves (advances) so that the device-side connector 16 is positioned below the vehicle-side connector 2, as shown in 3A. Subsequently, as shown in 3B, the self-propelled charging device 1 lifts the lower plate 13 upward by the motor 14, and lifts the device-side connector 16 upward by the lower plate 13.

Subsequently, as shown in 3C, the self-propelled charging device 1 moves the lower plate 13 further upward by the motor 14 to operate the respective joints 18 (see section A). Then, by bringing the upper surface of the device-side connector 16 into contact with the guide portion 21 of the vehicle-side connector 2, the device-side connector 16 and the device-side connector 16 are made parallel.

Subsequently, as shown in 3D, the self-propelled charging device 1 locks the device-side connector 16 to the vehicle-side connector 2 by slightly advancing (see part B). Subsequently, the self-propelled charging device 1 lowers the lower plate 13 downward while the device-side connector 16 is locked to the vehicle-side connector 2 (see section C), as shown in 3E. Finally, as shown in 3F, the self-propelled charging device 1 further advances to push the device-side connector 16 into the vehicle-side connector 2 to be connected. As described above, in the self-propelled charging device 1, the device-side connector 16 is vertically moved up and down by using the lower plate 13 to connect the device-side connector 16 to the vehicle-side connector 2 provided at the lower portion of the vehicle.

As described above, in the self-propelled charging device 1, by providing a plurality of joints 18 having two degrees of freedom or more on the base 17 of the device-side connector 16, tolerances can be absorbed by the joints 18 (see 3C of the drawings). This facilitates the alignment between the device-side connector 16 and the vehicle-side connector 2, so that the cost can be reduced by reducing the sensor for detecting the position of the vehicle-side connector 2.

Further, since the self-propelled charging device 1 is a self-propelled type in which the device itself moves, it is possible to wait at a different position until the vehicle is parked, and to move to the lower portion of the vehicle after parking. Accordingly, it is possible to charge various vehicles having different connector positions while there is no risk of being stepped on (touching) the vehicle.

### Embodiment 2

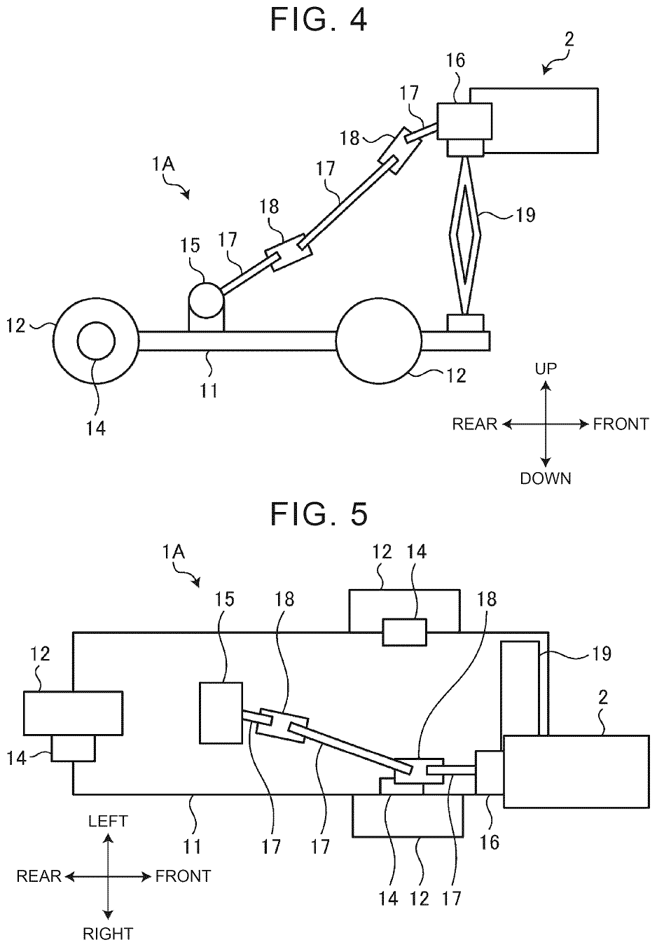

The configuration of the self-propelled charging device according to the second embodiment will be described with reference to FIGS. 4 and 5. The self-propelled charging device 1A according to the second embodiment includes a main body 11, a plurality of wheels 12, a plurality of motors 14, a rotating mechanism 15, a device-side connector 16, a plurality of bases 17, a plurality of joints 18, and an elevating mechanism 19. The self-propelled charging device 1A includes an elevating mechanism 19 instead of the lower plate 13 of the self-propelled charging device 1 described above.

The self-propelled charging device 1A is for performing charging via a vehicle-side connector 2 provided at a lower portion of the vehicle. As shown in FIG. 5, the device-side connector 16, the base 17, and the joints 18 are arranged along the front-rear direction of the self-propelled charging device 1A.

The elevating mechanism 19 is for raising and lowering the device-side connector 16. One end of the elevating mechanism 19 is fixed to the main body 11. The other end of the elevating mechanism 19 is fixed to the lower surface of the device-side connector 16. Further, the driving method of the elevating mechanism 19 is not particularly limited, and may be driven by, for example, a motor or may be driven using hydraulic pressure.

As described above, even when the elevating mechanism 19 is used in place of the lower plate 13, tolerances can be absorbed by the joint 18, and alignment between the device-side connector 16 and the vehicle-side connector 2 is facilitated. Accordingly, it is possible to reduce the cost by reducing the number of sensors for detecting the position of the vehicle-side connector 2.

### Embodiment 3

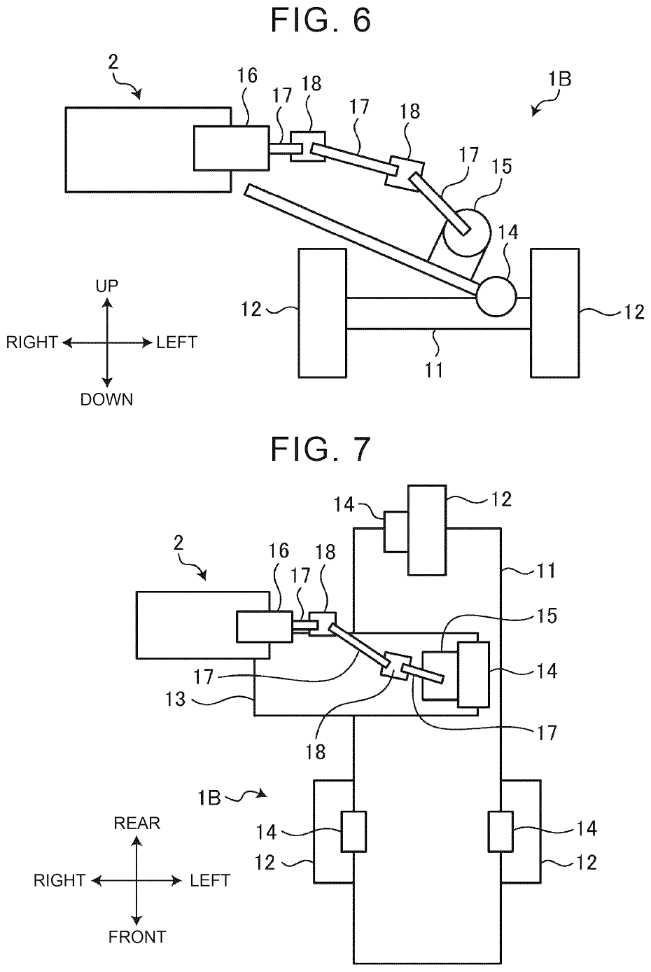

The configuration of the self-propelled charging device according to the third embodiment will be described with reference to FIGS. 6 and 7. The self-propelled charging device 1B according to the third embodiment includes a main body 11, a plurality of wheels 12, a lower plate 13, a plurality of motors 14, a rotating mechanism 15, a device-side connector 16, a plurality of bases 17, and a plurality of joints 18.

Further, the self-propelled charging device 1B is for performing charging via the vehicle-side connector 2 provided on the side surface of the vehicle, the lower plate 13, the device-side connector 16, the base 17 and the joints 18 are arranged along the left-right direction of the self-propelled charging device 1B.

The lower plate 13 is a plate-shaped member and functions as an elevating mechanism for raising and lowering the device-side connector 16. The lower plate 13 has, for example, a rectangular shape when viewed in a plan view as shown in FIG. 7, and the long sides are disposed toward the left and right sides of the self-propelled charging device 1B. One end of the lower plate 13 is supported by the main body 11. Further, a motor 14 for moving the lower plate 13 up and down with one end of the lower plate 13 as a base point is provided at one end of the lower plate 13.

As described above, even when the vehicle-side connector 2 is provided on the side surface of the vehicle, tolerances can be absorbed by the joint 18, and alignment between the device-side connector 16 and the vehicle-side connector 2 is facilitated. Accordingly, it is possible to reduce the cost by reducing the number of sensors for detecting the position of the vehicle-side connector 2.

### Embodiment 4

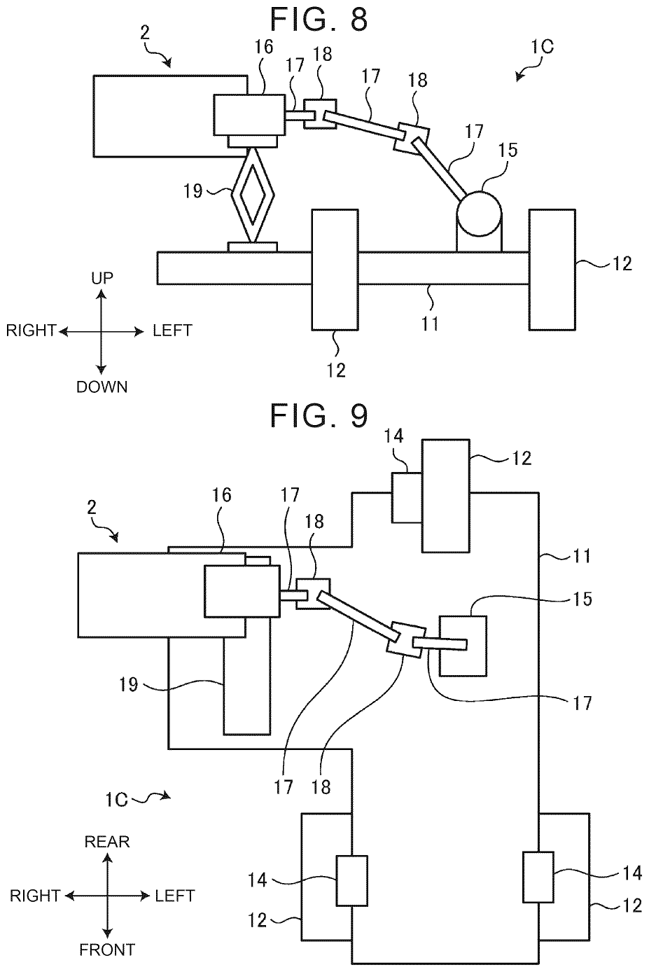

A configuration of the self-propelled charging device according to the fourth embodiment will be described with reference to FIGS. 8 and 9. The self-propelled charging device 1C according to the fourth embodiment includes a main body 11, a plurality of wheels 12, a plurality of motors 14, a rotating mechanism 15, a device-side connector 16, a plurality of bases 17, a plurality of joints 18, and an elevating mechanism 19. The self-propelled charging device 1C includes an elevating mechanism 19 instead of the lower plate 13 of the self-propelled charging device 1B.

Further, the self-propelled charging device 1C is for performing charging via the vehicle-side connector 2 provided on the side surface portion of the vehicle. As shown in FIG. 9, the device-side connector 16, the base 17, and the joints 18 are arranged along the left-right direction of the self-propelled charging device 1C.

The elevating mechanism 19 is for raising and lowering the device-side connector 16. One end of the elevating mechanism 19 is fixed to the main body 11. The other end of the elevating mechanism 19 is fixed to the lower surface of the device-side connector 16. Further, the driving method of the elevating mechanism 19 is not particularly limited, and may be driven by, for example, a motor or may be driven using hydraulic pressure.

As described above, even when the elevating mechanism 19 is used in place of the lower plate 13, tolerances can be absorbed by the joint 18, and alignment between the device-side connector 16 and the vehicle-side connector 2 is facilitated. Accordingly, it is possible to reduce the cost by reducing the number of sensors for detecting the position of the vehicle-side connector 2.

Additional effects and modifications are able to be easily derived by those skilled in the art. Thus, the broader aspects of the disclosure are not limited to the specific details and representative embodiments presented and described above. Accordingly, various modifications may be made without departing from the spirit or scope of the general inventive concept as defined by the appended claims and their equivalents.

What is claimed is:

1. A self-propelled charging device comprising:
a device-side connector that charges a battery of a vehicle by being connected to a vehicle-side connector;
an elevating mechanism that elevates and lowers the device-side connector; and
a plurality of joints having two or more degrees of freedom and provided on a base of the device-side connector.
